(19) United States
(12) Patent Application Publication
(10) Pub. No.: US 2016/0350771 A1
(43) Pub. Date: Dec. 1, 2016

(54) SURVEY FATIGUE PREDICTION AND IDENTIFICATION

(71) Applicant: QUALTRICS, LLC, Provo, UT (US)

(72) Inventor: Jason R. Gardner, Pleasant Grove, UT (US)

(21) Appl. No.: 14/727,511

(22) Filed: Jun. 1, 2015

(51) Int. Cl. G06Q 30/02

(52) U.S. Cl. CPC G06Q 30/0203

(57) ABSTRACT

Methods and systems for predicting and identifying survey fatigue associated with administering electronic surveys are provided. In particular, one or more embodiments comprise a survey management system that analyzes an electronic survey to determine whether the design of the electronic survey is likely to produce survey fatigue on the part of respondents. This allows the survey management system to assist administrators in designing electronic surveys that reduce survey fatigue and lead to more accurate survey results. Furthermore, one or more embodiments comprise a survey management system that analyzes responses to an electronic survey to determine whether responses were affected by survey fatigue. Accordingly, by excluding survey-fatigued responses, one or more embodiments enable an administrator to review more accurate survey results.

### CROSS REFERENCE TO RELATED APPLICATIONS

N/A.

### BACKGROUND

1. Technical Field

One or more embodiments relate generally to administering electronic surveys. More specifically, one or more embodiments relate to methods and systems of predicting and identifying survey fatigue associated with administering electronic surveys.

2. Background and Relevant Art

Surveys facilitate the gathering of information from respondents, which can then be used to draw inferences, reach conclusions, or make decisions. In general, surveys can be divided into two categories—traditional surveys and electronic surveys. Traditional surveys usually involve taking in-person interviews of respondents or using printed questionnaires completed by respondents. In contrast, electronic surveys typically involve questioning respondents using Internet-connected computing devices.

While traditional surveys are very useful, they often present several disadvantages. For instance, traditional surveys are inconvenient, as they can be difficult to distribute to large numbers of respondents. Furthermore, traditional surveys are typically expensive, time consuming, and error prone, which results from the significant amounts of manual human involvement required to design, conduct, and analyze such surveys. Moreover, traditional surveys are generally inflexible. For instance, traditional surveys normally follow a fixed format that does not dynamically change based on the information provided by respondents. Accordingly, given the disadvantages of traditional surveys, electronic surveys attempt to address these shortcomings.

Generally speaking, electronic surveys help mitigate or eliminate some of the disadvantages associated with traditional surveys. In particular, electronic surveys are advantageous, as they can be easier to distribute to large numbers of respondents. Moreover, electronic surveys are usually less expensive, less time consuming, and more accurate than traditional surveys. Furthermore, electronic surveys are typically quite flexible. For instance, in many cases electronic surveys are programmed to dynamically change based on the information provided by respondents. Accordingly, electronic surveys offer various advantages over traditional surveys.

Nevertheless, while electronic surveys offer some advantages, they still present various problems, including problems relating to inaccurate electronic survey results caused by survey fatigue. Survey fatigue occurs when respondents get tired while taking surveys and the quality of information provided by respondents deteriorates accordingly. In many cases, surveys simply attempt to obtain as much information as possible from respondents, without regard to the respondents' commitment to provide that amount of information. This often results in excessively long surveys that cause respondent irritation and survey fatigue, potentially resulting in incomplete surveys and/or inaccurate survey responses. For example, respondents may experience survey fatigue due to survey length, survey design, or a variety of other factors, some of which may be external to the administration of the electronic survey itself. This frequently prevents respondents from answering surveys accurately and in full. As such, survey fatigue adversely impacts the effectiveness of surveys in general.

For traditional surveys administered using at least some interpersonal interaction (e.g., in-person or over the phone), survey administrators are able to identify potential survey fatigue (e.g., using visual and/or audible cues and feedback from the respondents). As such, traditional survey administrators are able to identify survey responses influenced by survey fatigue. However, identifying survey fatigue based on interpersonal interactions is not a possibility when it comes to electronic surveys. In particular, electronic surveys are administered electronically (e.g., via the Internet) without the need for any interpersonal interactions between survey administrators and survey respondents. As a result, typical electronic survey methods and systems treat responses potentially affected by survey fatigue in the same manner as all other responses, which can result in ineffective electronic surveys that support erroneous conclusions. Accordingly, although the use of electronic surveys provides a number of conveniences and efficiencies, it creates a unique problem with respect to predicting, identifying, and/or mitigating survey fatigue.

Accordingly, there are a number of considerations to be made in administering electronic surveys and predicting and identifying survey fatigue associated with administering electronic surveys.

### SUMMARY

Embodiments disclosed herein provide benefits and/or solve one or more of the foregoing or other problems in the art with methods and systems for administering electronic surveys. In particular, one or more embodiments improve the accuracy of electronic survey results and the effectiveness of electronic surveys in general by predicting and/or identifying survey fatigue associated with administering electronic surveys. For example, one or more embodiments provide methods and systems for determining whether electronic surveys are likely to produce survey fatigue on the part of respondents. As a further example, one or more embodiments provide methods and systems for determining whether responses to electronic surveys were affected by survey fatigue on the part of respondents.

Moreover, one or more embodiments mitigate the potential for survey fatigue by assisting in the design of electronic surveys. For example, some embodiments predict survey fatigue based on a consideration of respondents' commitment to provide complete and accurate responses. Furthermore, various embodiments provide notifications of electronic surveys designed in a manner likely to cause survey fatigue. Embodiments also improve electronic surveys by facilitating the design of electronic surveys of appropriate lengths in order to avoid respondent irritation and survey fatigue. In addition, one or more embodiments eliminate the need to ask respondents “wakeup questions” by providing for the latent detection of responses affected by survey fatigue.

Furthermore, one or more embodiments reduce the adverse effects of survey fatigue by improving the accuracy of electronic survey results. For example, certain embodiments identify potentially survey-fatigued responses based on the attention levels of respondents. More specifically, one or more embodiments identify survey fatigue by determining the attention levels of respondents using an analysis of actual responses in comparison to expected responses. Moreover, one or more embodiments differentiate between survey-fatigued responses and accurate responses. Accordingly, certain embodiments improve the accuracy of electronic survey results by not treating responses potentially affected by survey fatigue in same manner as other responses, thereby lessening the likelihood of administering ineffective electronic surveys that support erroneous conclusions.

Additional features and advantages of exemplary embodiments will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features can be obtained, a more particular description will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots, etc.) are used herein to illustrate optional features or operations that add additional features to one or more embodiments. Such notation, however, should not be taken to mean that these are the only options or optional operations, and/or that blocks with solid borders are not optional in certain embodiments. Understanding that these drawings depict only typical embodiments and are not therefore to be considered to be limiting, embodiments will be described and explained with additional specificity and detail through the use of the accompanying drawings in which:

FIG. 1 illustrates a schematic diagram of a system for administering electronic surveys using an administrator device, a survey management system, and multiple respondent devices in accordance with one or more embodiments;

FIG. 2 illustrates a detailed schematic diagram of the survey management system of FIG. 1 in accordance with one or more embodiments;

FIGS. 3A-3B illustrate a sequence-flow diagram of interactions between the administrator device, survey management system, and a respondent device of FIG. 1 in accordance with one or more embodiments;

FIG. 4 illustrates a respondent commitment table in accordance with one or more embodiments;

FIG. 5 illustrates a flowchart of a series of acts in a method of administering an electronic survey using a survey management system in accordance with one or more embodiments;

FIG. 6 illustrates a flowchart of a series of acts in a method of administering an electronic survey using a survey management system in accordance with one or more embodiments;

FIG. 7 illustrates a block diagram of an exemplary computing device in accordance with one or more embodiments; and

FIG. 8 illustrates an example network environment of a survey management system in accordance with one or more embodiments.

### DETAILED DESCRIPTION

One or more embodiments disclosed herein improve the accuracy of electronic survey results and the effectiveness of electronic surveys in general by providing a survey management system that predicts and/or identifies survey fatigue associated with administering electronic surveys. In particular, the survey management system determines whether electronic surveys are likely to produce survey fatigue on the part of respondents. Moreover, the survey management system determines whether responses to electronic surveys were affected by survey fatigue on the part of respondents. Accordingly, the survey management system provides a number of useful features that benefit survey administrators, as described in further detail below.

For example, one or more embodiments improve the design of electronic surveys by providing a survey management system that predicts survey fatigue based on a survey definition and respondent pool information (e.g., respondent loyalty). More specifically, the survey management system analyzes a survey design of an electronic survey to determine an expected survey duration (i.e. the time it should take for a respondent to accurately answer the survey). Further, the survey management system analyzes respondent pool information associated with the electronic survey to identify an expected respondent commitment duration (i.e. the time an intended or potential respondent is likely to devote to answering the survey). The survey management system then compares the expected survey duration to the expected respondent commitment duration to determine whether the electronic survey is likely to produce survey fatigue (i.e. whether the electronic survey will take longer than a respondent is likely to commit). Accordingly, the survey management system may provide an administrator with a notification of likelihood of survey fatigue (e.g., a binary indicator, flag, percentage likelihood, probability range, etc.) and/or an opportunity to modify the electronic survey to reduce or eliminate the potential for survey fatigue. Thus, one or more embodiments facilitate the redesign of electronic surveys to avoid survey fatigue and improve the effectiveness of electronic surveys, as described in more detail in reference to the figures below.

As another example, one or more embodiments improve the accuracy of electronic survey results by providing a survey management system that identifies responses affected by survey fatigue. In particular, the survey management system analyzes a response in comparison to one or more other responses provided by a respondent. For example, the survey management system identifies survey fatigue by comparing response durations for a respondent's responses. As an alternative example, the survey management system identifies survey fatigue by analyzing the variability in answers provided by a respondent. Further, the survey management system may provide an administrator with an indication that a response was affected by survey fatigue and/or exclude responses affected by survey fatigue from the electronic survey results. Accordingly, one or more embodiments improve the effectiveness of electronic surveys by providing for the analysis of more accurate survey results, as described in greater detail with reference to the figures below.

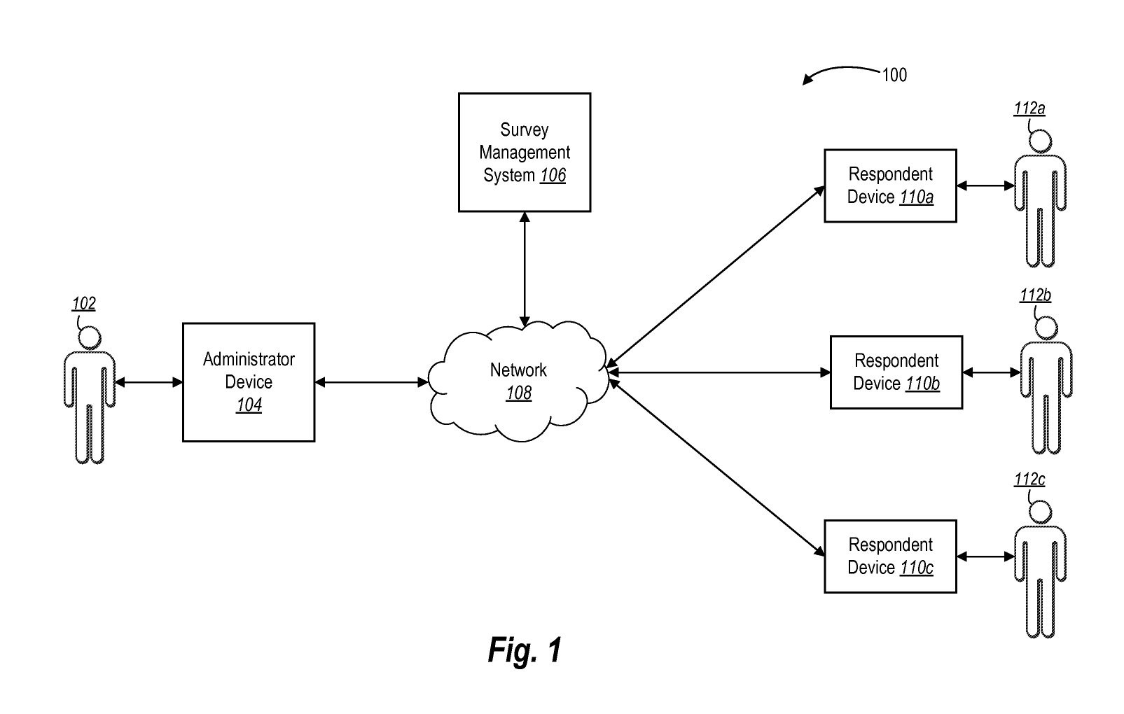

FIG. 1 is a schematic diagram of a system 100 for administering electronic surveys using an administrator device, a survey management system, and multiple respondent devices in accordance with one or more embodiments. An overview of the system 100 will be described next in relation to FIG. 1. Thereafter, a more detailed description of the components and processes of the system 100 will be described in relation to the remaining figures.

As illustrated by FIG. 1, the system 100 can include an administrator 102, an administrator device 104, a survey management system 106, a network 108, respondent devices 110a-110c, and respondents 112a-112c. By communicating with administrator device 104 through network 108, survey management system 106 can facilitate the management of electronic surveys by administrator 102.

More specifically, in one or more embodiments, survey management system 106 can communicate with administrator device 104 to aid administrator 102 in creating, disseminating, and reviewing electronic surveys and electronic survey results. For example, by communicating with administrator device 104, survey management system 106 can support administrator 102 in designing and building electronic surveys (e.g., by creating questions, answer choices, logic that controls the display of each electronic survey, and/or the look and feel of each electronic survey, etc.). As another example, by communicating with administrator device 104, survey management system 106 can assist administrator 102 in administering and distributing electronic surveys to one or more respondents, such as respondents 112a-112c (e.g., by distributing electronic surveys via email, Short Message Service (SMS), social media, webpage pop-up, anonymous survey link, and/or unique survey links, etc.). As a further example, by communicating with administrator device 104, survey management system 106 can support administrator 102 in viewing and analyzing electronic survey results (e.g., by examining individual responses to questions and/or reports summarizing the electronic survey results, etc.).

Moreover, in one or more embodiments, survey management system 106 can communicate with administrator device 104 to provide administrator 102 with a notification that an electronic survey is likely to produce survey fatigue on the part of respondents. Additionally or alternatively, in one or more embodiments, survey management system 106 can communicate with administrator device 104 to provide administrator 102 with an indication of survey responses that were potentially affected by survey fatigue.

As FIG. 1 also illustrates, survey management system 106 can facilitate the dissemination of electronic surveys to respondents 112a-112c, and the collection of electronic survey results from respondents 112a-112c, by communicating with respondent devices 110a-110c through network 108. For example, by communicating with respondent devices 110a-110c, survey management system 106 can administer and distribute electronic surveys to respondents 112a-112c. As a further example, by communicating with respondent devices 110a-110c, survey management system 106 can receive and store the electronic survey responses of respondents 112a-112c.

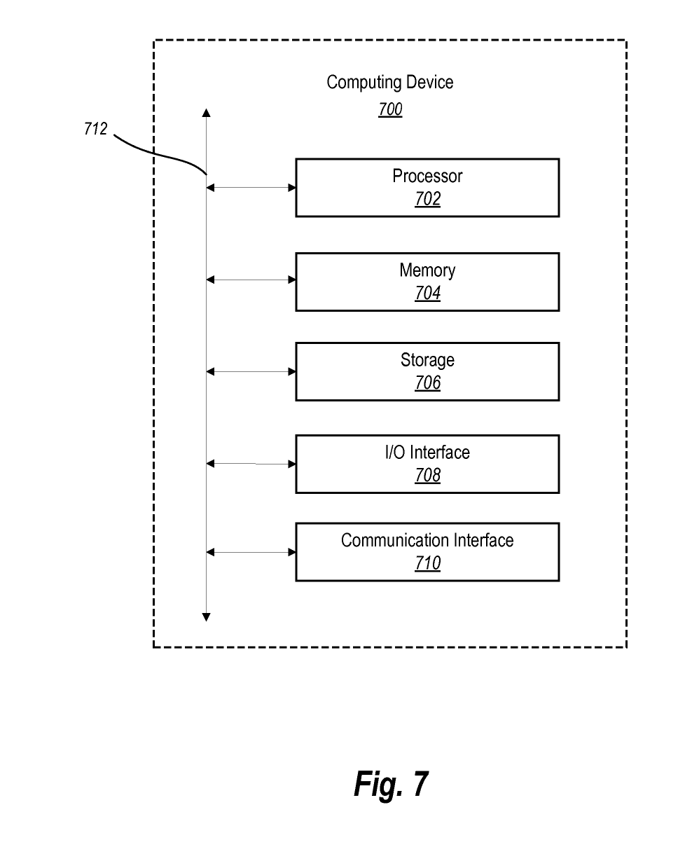

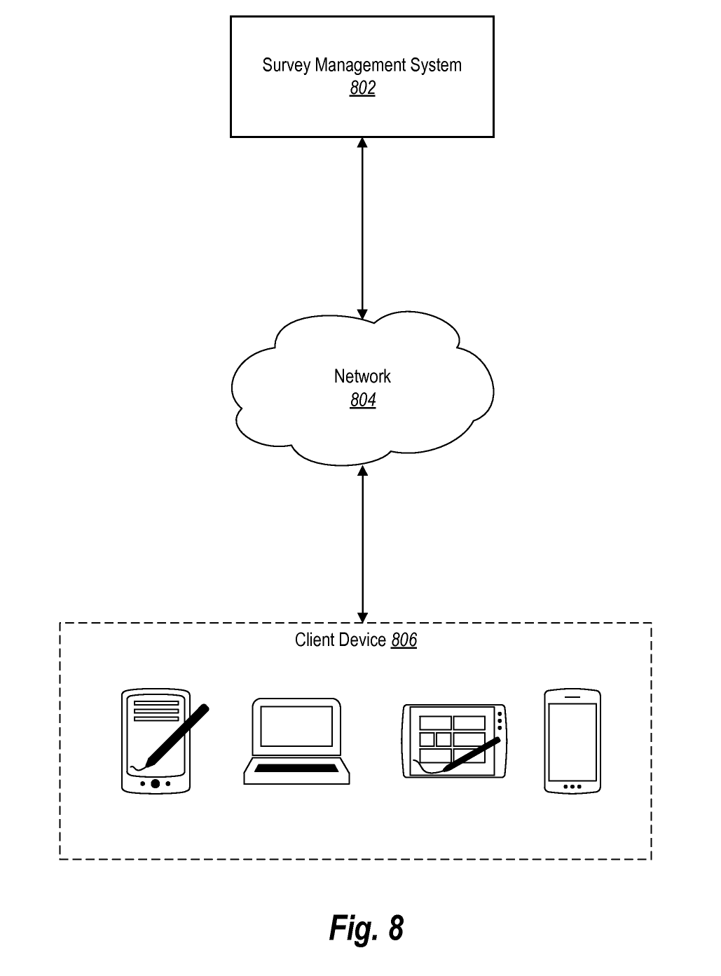

Survey management system 106 can include one or more computing devices, such as described in further detail with respect to FIGS. 7 and 8. For example, survey management system 106 can include one or more server computers. Likewise, administrator device 104 and respondent devices 110a-110c can each include one or more computing devices, such as described in further detail with respect to FIGS. 7 and 8. For example, administrator device 104 can include a desktop computer and respondent devices 110a-110c can each include a laptop computer. Moreover, network 108 can include any type of network, as described in further detail with respect to FIGS. 7 and 8. For example, network 108 can include the Internet. Furthermore, administrator 102 can include any person who uses electronic surveys to gather information (e.g., an academic user, such as a professor or student, or a business user, such as a manager or employee). Similarly, each respondent 112a-112c can include any person who may respond to electronic surveys (e.g., an existing customer, a potential customer, an employee, or a student).

While FIG. 1 illustrates administrator 102 and administrator device 104, one will appreciate that one or more embodiments can include any number of administrators and administrator devices. Similarly, while FIG. 1 illustrates respondents 112a-112c and respondent devices 110a-110c, one will appreciate that one or more embodiments can include any number of respondents and respondent devices.

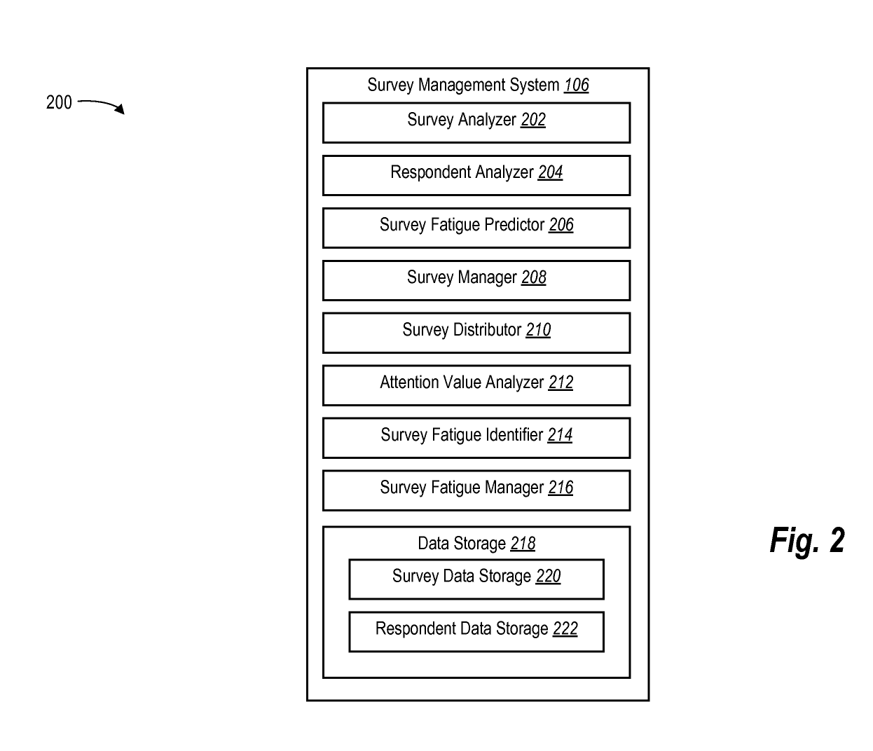

FIG. 2 illustrates an example embodiment of the survey management system 106 of FIG. 1. In particular, FIG. 2 illustrates that the survey management system 106 can include a survey analyzer 202, a respondent analyzer 204, a survey fatigue predictor 206, a survey manager 208, a survey distributor 210, an attention value analyzer 212, a survey fatigue identifier 214, and a survey fatigue manager 216. In addition, FIG. 2 illustrates that the survey management system 106 can include a data storage 218, which, in one or more embodiments, can further include survey data storage 220 and respondent data storage 222. As explained in greater detail below, each component 202-222 of the survey management system 106 can execute on and/or be implemented by one or more computing devices.

As FIG. 2 illustrates, the survey management system 106 can include a survey analyzer 202. In one or more embodiments, the survey analyzer 202 can analyze an electronic survey to identify information relevant to survey fatigue. For example, the survey analyzer 202 can analyze an electronic survey to determine an expected survey duration for the electronic survey (i.e. an expected time for a respondent to accurately complete the electronic survey). In particular, the survey analyzer 202 determines the expected survey duration by analyzing one or more elements of the electronic survey (e.g., questions, answer choices, pages, respondent interactions, other electronic survey characteristics, etc.). For example, the survey analyzer 202 can identify an element duration (i.e. an expected time for a respondent to accurately comprehend, process, and/or answer an element) for each element of the electronic survey and then sum each element duration to determine the expected survey duration for the electronic survey.

In one or more embodiments, the survey analyzer 202 can analyze a survey definition of the electronic survey to determine the expected survey duration. A survey definition can include an indication of the elements of the electronic survey and/or information related to the survey elements. For example, a survey definition can include an indication of the questions of the electronic survey, as well as display logic that specifies how to display the electronic survey to respondents (e.g., which questions to display on each page of the electronic survey, controlling the conditional display of questions and/or answer choices, for example, based on prior input from the respondent, etc.). The survey analyzer 202 can access a survey definition of an electronic survey that is stored in data storage 218 (e.g., in survey data storage 220), as described in further detail below. Additionally or alternatively, the survey analyzer 202 can receive a survey definition of an electronic survey from administrator device 104.

Additionally or alternatively, the survey analyzer 202 can determine an expected survey duration by analyzing one or more of various elements of an electronic survey. To illustrate, in one or more embodiments, the survey analyzer 202 determines an expected survey duration for an electronic survey by analyzing each of the questions of the electronic survey, determining a question duration for each question, and summing the determined question durations to determine the total expected survey duration for the electronic survey or at least a portion of the electronic survey. In some embodiments, the survey analyzer 202 determines a question duration for each question by dividing a word count for the question by an expected respondent reading speed. The expected respondent reading speed can be a general average reading speed (e.g., average words per minute of a native English speaker), an average reading speed for a particular group of users (e.g., average words per minute for users within a respondent pool), and/or a reading speed for a specific individual (e.g., for a specific respondent, for which reading speed information was previously acquired, such as based on previous survey responses by the respondent).

In additional or alternative embodiments, the survey analyzer 202 can determine an element duration for a survey element based on a type of the survey element. To illustrate, the survey analyzer 202 can determine a question duration for a question by identifying a question time value associated with a question type for the question. For example, the survey analyzer 202 can identify a question type (e.g., multiple choice question, text entry question, or matrix table question) and then look up a question time value for the identified question type (e.g., by looking up the question time value in a table or other suitable data structure that associates question types with corresponding question time values).

Additionally or alternatively, the survey analyzer 202 can determine an expected survey duration for an electronic survey based in part on an analysis of answer choices for each question in the electronic survey. For example, the survey analyzer 202 can determine an answer choice duration for each answer and then sum each answer choice duration to determine an expected duration of at least a portion of the electronic survey. In one or more embodiments, the survey analyzer 202 determines an answer choice duration by dividing a word count for an answer choice by an expected respondent reading speed. As another example, the survey analyzer 202 can determine an answer choice duration by identifying an answer type (e.g., text entry, multiple choice, matrix table) for the answer choice and then identifying an answer time value associated with the answer choice type (e.g., by looking the answer time value up in a table or other suitable data structure that associates answer choice types with corresponding answer time values). Therefore, as one can appreciate, the survey analyzer 202 can determine at least a portion of an expected survey duration based on the determined answer choice durations.

Further, in one or more embodiments, the survey analyzer 202 can determine an expected survey duration for an electronic survey based at least in part on an analysis of each of the pages of the electronic survey. More specifically, in one or more embodiments the survey analyzer 202 determines a page duration for each page and sums each page duration to determine at least a portion of the expected survey duration. As an example, the survey analyzer 202 determines a page duration for each page by summing the time required to scroll through the page (i.e. scrolling time) with the question durations for each question presented on the page. Moreover, the scroll time may vary based on the respondent device (e.g., shorter scroll times on desktop computing devices having larger screens, in contrast to longer scroll times on mobile computing devices with smaller screens). Additionally, the survey analyzer 202 may determine the page duration for each page by adding page load times or time values to account for the number of questions on the page.

Moreover, in one or more embodiments the survey analyzer 202 determines an expected survey duration for an electronic survey by analyzing respondent interactions that may occur while taking the electronic survey. More precisely, in one or more embodiments the survey analyzer 202 determines a respondent interaction duration for each page of the electronic survey. For example, the survey analyzer 202 determines a respondent interaction duration for each page by determining one or more time values to account for one or more of respondent eye movement (e.g., while reading each page), respondent input (e.g., providing answers, selecting a next button to proceed to a subsequent page in the electronic survey, etc.), respondent scrolling (e.g., to view other portions of each page), or any other respondent interaction(s) with the electronic survey or a device displaying the electronic survey. Additionally, in one or more embodiments the survey analyzer 202 determines a respondent interaction duration for each page at least in part by determining one or more time values to account for respondent cognitive functioning (e.g., thinking, deliberating, reflecting, recalling, etc.).

Also, in one or more embodiments the survey analyzer 202 determines an expected survey duration for an electronic survey by analyzing one or more other characteristics of the electronic survey. For example, in one or more embodiments the survey analyzer 202 determines an expected survey duration for an electronic survey by analyzing a survey type of the electronic survey. More specifically, in one or more embodiments the survey analyzer 202 determines an expected survey duration by looking up in a table or other suitable data structure a time value associated with the survey type of the electronic survey. In one or more embodiments, the time values associated with survey types can be predetermined and/or based off of historical data compiled by the survey management system 106 from previous surveys. Regardless, various survey types are voluntary or mandatory surveys, including market survey types (e.g., ad testing surveys, concept testing surveys, customer satisfaction surveys, market research surveys, NET PROMOTER score surveys, etc.), employee survey types (e.g., employee assessment surveys, employee engagement surveys, employee exit interview surveys, etc.), or academic survey types (e.g., test surveys, examination surveys, etc.).

As another example, in one or more embodiments the survey analyzer 202 determines an expected survey duration for an electronic survey by analyzing an administrator category associated with administrator 102. In particular, the survey analyzer determines an expected survey duration by looking up in a table or other suitable data structure a time value associated with the administrator category. As used herein, an administrator category is a classification that describes the business or activities of a survey administrator. Various administrator categories include an academic category, a consumer goods category, a financial services category, a healthcare category, a media category, a communications category, a research services category, a professional services category, a retail category, a technology category, a travel category, a hospitality category, a restaurant category, etc.

As yet another example, in one or more embodiments the survey analyzer 202 determines an expected survey duration for an electronic survey by analyzing one or more hidden elements of the electronic survey. More specifically, the survey analyzer 202 determines an expected survey duration by looking up in a table or other suitable data structure a time value associated with each hidden element. Examples of hidden elements include timers (e.g., survey, page, or question timers), metadata, survey authentication, or survey display logic (e.g. question and/or page ordering or flow, question and/or page randomization, etc.).

Moreover, in one or more embodiments the survey analyzer 202 determines an expected survey duration for an electronic survey based on a plurality of survey durations. For example, the survey analyzer 202 determines an expected survey duration based on a plurality of survey durations generated by simulating administration of the survey multiple times (e.g., the expected survey duration may be the average or median of the plurality of survey durations). As another example, the survey analyzer 202 determines an expected survey duration based on a plurality of survey durations, each of which is generated by a different path through the electronic survey (e.g., by answering questions and/or navigating pages differently, or by permuting the questions and/or pages differently). More specifically, the survey analyzer 202 determines an expected survey duration by determining a first survey duration based on a first path through the electronic survey and a second survey duration based on a second path through the electronic survey, such that the expected survey duration is the average of the first survey duration and the second survey duration.

Furthermore, in one or more embodiments the survey analyzer 202 may analyze the expected survey duration of an electronic survey based on information provided by administrator 102. For example, administrator 102 may provide information relevant to determining the expected survey duration, such as expected reading speed of respondents, expected language of respondents, expected page, survey, or network latency, etc. As another example, the administrator 102 may provide an expected survey duration and/or individual element durations. As yet a further example, the administrator 102 may override the expected survey duration and/or element durations determined by survey analyzer 202. This, in turn, may facilitate the survey management system 106 in providing administrator with a more accurate prediction of survey fatigue caused by electronic surveys and/or a more precise identification of responses to electronic surveys affected by survey fatigue.

In addition, in one or more embodiments the survey analyzer 202 may update an expected survey duration (or individual expected element durations) for an electronic survey based on the actual response times detected when administering the electronic survey. For example, the survey analyzer 202 may update an expected survey duration for an electronic survey from 10:00 minutes to 7:00 minutes if, during administration of the electronic survey, survey management system 106 detects that respondents are typically taking 7:00 minutes to accurately complete the electronic survey. Accordingly, the survey management system 106 can learn for the benefit of making expected survey durations and/or particular element durations more accurate, which in turn may lead to less survey fatigue and more accurate survey results.

As FIG. 2 also illustrates, the survey management system 106 can include a respondent analyzer 204. In one or more embodiments, the respondent analyzer 204 can identify an expected respondent commitment duration for the electronic survey (i.e. an expected time for a respondent to commit when taking the electronic survey). In particular, the respondent analyzer 204 can identify an expected respondent commitment duration by analyzing respondent pool information (i.e. information that identifies intended or potential respondents or characteristics of such respondents, like respondent loyalty). Respondent analyzer 204 may obtain respondent pool information by prompting administrator 102 to provide information or characteristics regarding intended or potential respondents of the electronic survey. Alternatively, respondent analyzer 204 may obtain respondent pool information by accessing respondent data storage 222 to identify intended or potential respondents, as well as characteristics pertaining to such respondents (e.g., how long such respondents typically commit to taking electronic surveys). As a further alternative, respondent analyzer 204 may automatically determine an expected respondent commitment duration and/or expected respondent commitment level based on various factors (e.g., survey type, survey context, incentives offered to respondents, etc.).

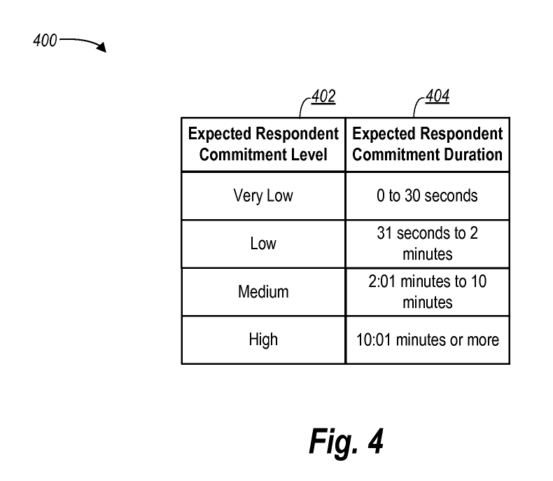

In one or more embodiments, respondent pool information can include an expected respondent commitment level (e.g., very low, low, medium, or high). Accordingly, the respondent analyzer 204 can identify an expected respondent commitment level indicated by the respondent pool information in order to identify an expected respondent commitment duration that corresponds to the expected respondent commitment level. For example, the respondent analyzer 204 may identify the expected respondent commitment duration by looking up in a table or other suitable data structure an expected respondent commitment level that corresponds to the expected respondent commitment duration (e.g., as shown by FIG. 4 and described in further detail below).

Moreover, in one or more embodiments the respondent analyzer 204 identifies an expected respondent commitment duration based on the durations of one or more prior electronic surveys taken by respondents identified in the respondent pool information. In particular, the respondent analyzer 204 uses one or more respondent profiles indicated by the respondent pool information to identify respondent commitment durations (i.e. durations of one or more prior electronic surveys taken by the respondents, which may be stored generally in data storage 218 or more particularly in respondent data storage 222). The respondent analyzer 204 then uses the respondent commitment durations to determine the expected respondent commitment duration (e.g., by computing the average or median of all respondent commitment durations for electronic surveys previously taken by respondents identified in the respondent pool information).

Furthermore, in one or more embodiments the respondent analyzer 204 identifies an expected respondent commitment duration based on the survey type of the electronic survey. More specifically, the respondent analyzer 204 identifies the survey type of the electronic survey in order to identify an expected respondent commitment duration that corresponds to the survey type. For example, the respondent analyzer 204 identifies the expected respondent commitment duration by looking up in a table or other suitable data structure the survey type that corresponds to the expected respondent commitment duration (e.g., an expected respondent commitment duration may include a predetermined time period associated with a survey type of an electronic survey).

Additionally, in one or more embodiments the respondent analyzer 204 identifies an expected respondent commitment duration based on the administrator category associated with the electronic survey and/or the administrator 102. In particular, the respondent analyzer 204 identifies an administrator category of the electronic survey in order to identify an expected respondent commitment duration that corresponds to the administrator category. As an example, the respondent analyzer 204 identifies the expected respondent commitment duration by looking up in a table or other suitable data structure the administrator category that corresponds to the expected respondent commitment duration (e.g., an expected respondent commitment duration may include a predetermined time period associated with an administrator category of an electronic survey).

Moreover, in one or more embodiments the survey management system 106 may provide a recommendation for a respondent incentive based on various factors, including the expected survey duration determined by survey analyzer 202 and/or the expected respondent commitment level or duration identified by respondent analyzer 204. For example, if the expected respondent commitment level is “high” or the survey type is “mandatory”, then the survey management system 106 may recommend no incentive to the administrator. Alternatively, if the expected respondent commitment level is “low” or the survey type is “voluntary”, then the survey management system 106 may recommend that the administrator provide an incentive to respondents in order to prevent survey fatigue (e.g., a low incentive valued at $5 up to a high incentive valued at $50). Furthermore, the survey management system 106 may recommend incentives based on the difference between the expected survey duration and the expected respondent commitment duration (e.g., by recommending greater incentives as the difference between the respective durations increases).

As further shown by FIG. 2, in one or more embodiments the survey management system 106 can include a survey fatigue predictor 206 that determines whether an electronic survey is likely to produce survey fatigue. As one will appreciate, the survey fatigue predictor 206 can predict survey fatigue for one or more individual elements of an electronic survey or for an entire electronic survey. In particular, the survey fatigue predictor 206 utilizes the expected survey duration (or portions thereof) and the expected respondent commitment duration (or portions thereof) to determine whether an electronic survey is likely to produce survey fatigue. For example, the survey fatigue predictor 206 determines that an electronic survey is likely to produce survey fatigue if the expected survey duration (e.g., the expected survey duration determined by survey analyzer 202) is greater than the expected respondent commitment duration (e.g., the expected respondent commitment duration identified by respondent analyzer 204). In one or more embodiments, the survey fatigue predictor 206 compares the expected survey duration to the expected respondent commitment duration to determine whether the expected survey duration is greater than the expected respondent duration. Alternatively, the survey fatigue predictor 206 determines the difference between the expected survey duration and the expected respondent commitment duration (e.g., by subtraction) to determine whether the expected survey duration is greater than the expected respondent duration.

As another alternative, in one or more embodiments the survey fatigue predictor 206 determines that an electronic survey is likely to produce survey fatigue if the expected survey duration exceeds the expected respondent commitment duration by a threshold value. For example, the survey fatigue predictor 206 obtains a threshold value by prompting administrator 102 to provide the threshold value. As another example, the survey fatigue predictor 206 identifies a predetermined threshold value stored by survey management system 106 (e.g., a threshold value, such as a standard deviation or percentage, stored in data storage 218 in general, or survey data storage 220 in particular).

FIG. 2 also shows that the survey management system 106 can include a survey manager 208. In one or more embodiments, the survey manager 106 can perform one or more actions to manage or notify a survey administrator of predicted survey fatigue. For example, in some embodiments, the survey manager 208 provides a notification of the likelihood that an electronic survey will produce survey fatigue. In particular, the survey manager 208 provides a notification of likelihood of survey fatigue to administrator 102. For example, the survey manager 208 provides the notification of likelihood of survey fatigue when it is determined that an electronic survey is likely to produce survey fatigue. Alternatively, the survey manager 208 provides the notification of likelihood of survey fatigue regardless of whether an electronic survey is likely to produce survey fatigue. Furthermore, the survey manager 208 provides the notification of likelihood of survey fatigue at any time, including prior to, during, and after administration of an electronic survey.

Moreover, in one or more embodiments the notification of likelihood of survey fatigue can take various forms. For example, the notification of likelihood of survey fatigue can include a binary indicator (e.g., a user interface element on a webpage, such as an icon, flag, or other indicator). As another example, the notification of likelihood of survey fatigue can include an indicator presented in an electronic communication (e.g., an email, text message, or instant message containing a user interface element that indicates the likelihood of survey fatigue associate with a particular electronic survey).

As another example, in one or more embodiments the notification of likelihood of survey fatigue can include a user interface element that indicates the magnitude of the likelihood of survey fatigue. For example, the notification of likelihood of survey fatigue can include a gauge (e.g., a circular gauge, semi-circular gauge, linear gauge, etc.) that indicates the likelihood of survey fatigue. More specifically, the gauge can indicate the expected survey duration (e.g., displayed as a number of minutes and as determined by survey analyzer 202). Additionally or alternatively, the gauge can indicate the expected survey duration as a gauge level. Moreover, the gauge can indicate the likelihood of survey fatigue by the color of the gauge level (e.g., “green” for a negligible likelihood for survey fatigue and “red” for a significant likelihood of survey fatigue). In one or more embodiments, the survey manager 208 can determine the color of the gauge level based on a comparison of the expected survey duration to the expected respondent commitment duration (e.g., “green” if the expected survey duration is less than or equal to the expected respondent commitment duration and “red” if the expected survey duration is greater than the expected respondent commitment duration).

Furthermore, in one or more embodiments the notification of likelihood of survey fatigue can change to correspond to the expected survey duration as an electronic survey is modified (e.g., made longer by the addition of questions or shorter by the removal of questions). For example, the gauge can update the indication of the expected survey duration (e.g., by changing the number of minutes displayed and/or the gauge level) in response to modification of the electronic survey.

Additionally, in one or more embodiments the notification of likelihood of survey fatigue is provided before an electronic survey is activated for distribution. More specifically, the survey manager 208 can determine that an electronic survey is not activated for distribution and then provide the notification of likelihood of survey fatigue based on that determination. Alternatively, in one or more embodiments the notification of likelihood of survey fatigue is provided regardless of whether an electronic survey is activated for distribution. For example, the survey manager 208 can provide the notification of likelihood of survey fatigue for all electronic surveys, regardless of distribution status.

As yet a further example, in one or more embodiments the notification of likelihood of survey fatigue can include detailed information concerning the likelihood of survey fatigue arising from a particular electronic survey. More specifically, in one or more embodiments the notification of likelihood of survey fatigue includes one or more of an indication of the expected survey duration (e.g., as determined by survey analyzer 202), an indication of the expected respondent commitment duration (e.g., as determined by respondent analyzer 204), an indication of the difference between the expected survey duration and the expected respondent commitment duration, or an indication of element durations for the elements of the electronic survey (e.g., question durations for each question, answer choice durations for each answer, page durations for each page, etc.). Accordingly, in one or more embodiments the administrator 102 can use this information to modify the electronic survey to minimize the potential for survey fatigue or potentially avoid survey fatigue altogether.

Furthermore, in one or more embodiments the survey manager 208 provides a suggestion to modify an electronic survey. More specifically, the survey manager 208 can provide an indication of one or more elements of the electronic survey that could be modified to further reduce the potential for survey fatigue. For example, the survey manager 208 can provide an identification of one or more elements and their corresponding element durations (e.g., questions and question durations, answer choices and answer choice durations, pages and page durations, etc.). As a further example, the survey manager 208 can provide an identification of the elements having the longest element durations (e.g., the longest questions, longest answer choices, longest pages, etc.). As an even further example, the survey manager 208 can provide a detailed suggestion to modify the electronic survey, which may include a suggestion for fewer questions (i.e. less question per page), fewer pages (i.e. more questions per page), and/or changes to conditional display logic or survey flow. As a result, an administrator (e.g., administrator 102) can use this information to modify an electronic survey in order to avoid survey fatigue.

In addition, in one or more embodiments an administrator can modify a survey definition in response to a suggestion to modify an electronic survey. Accordingly, the survey analyzer 202 may analyze one or more elements of a modified survey definition to determine a modified expected survey duration. Consequently, the survey fatigue predictor 206 can then utilize the modified expected survey duration to determine whether the modified electronic survey is likely to produce survey fatigue. In one or more embodiments, if survey fatigue predictor 206 determines that, based on the modified survey definition, a modified electronic survey is no longer likely to produce survey fatigue, then survey manager 208 removes any notifications of likelihood of survey fatigue previously related to the electronic survey.

Likewise, in one or more embodiments an administrator can modify respondent pool information in response to a suggestion to modify an electronic survey. Therefore, the respondent analyzer 204 may analyze modified respondent pool information to identify a modified expected respondent commitment duration. As a result, the survey fatigue predictor 206 can then utilize the modified expected respondent commitment duration to determine whether the modified electronic survey is likely to produce survey fatigue. In the event that survey fatigue predictor 206 determines that survey fatigue is no longer likely based on the modified respondent pool information, then survey manager 208 can remove any notifications of likelihood of survey fatigue previously related to the electronic survey.

Moreover, as shown by FIG. 2, in one or more embodiments the survey management system 106 can include a survey distributor 210 that distributes an electronic survey. In particular, the survey distributor 210 distributes an electronic survey to one or more respondents in a respondent pool (e.g., the respondents identified or indicated by respondent pool information analyzed by respondent analyzer 204 described above). For example, the survey distributor 210 can distribute an electronic survey to one or more respondents via email, Short Message Service (SMS), social media website, webpage pop-up, anonymous survey links or unique survey links (e.g., hyperlinks), mobile applications (e.g., offline survey applications) or other electronic communication channels. Furthermore, in one or more embodiments the survey distributor 210 identifies respondents by referring to respondent pool information associated with the electronic survey to be distributed. Alternatively, in one or more embodiments the survey distributor 210 identifies respondents for an electronic survey by accessing respondent data storage 222 and/or respondent profiles stored therein.

Additionally, in one or more embodiments the survey distributor 210 distributes a portion of the electronic survey to one or more respondents in the respondent pool. More specifically, the survey distributor 210 distributes less than the entirety of an electronic survey by sending one or more elements of the electronic survey to one or more respondents. For example, the survey distributor 210 can distribute a single question and corresponding answer choices to one or more respondents. As a different example, the survey distributor 210 distributes a single page, including one or more questions and answer choices, to one or more respondents. Moreover, in one or more embodiments, the survey distributor 210 collects responses from respondents (e.g., responses to individual questions, pages, and/or electronic surveys as a whole). Accordingly, distributing portions of electronic surveys supports identifying survey fatigue in real-time, as described in further detail below with respect to survey fatigue identifier 214.

Furthermore, FIG. 2 illustrates that in one or more embodiments the survey management system 106 can include an attention value analyzer 212 that analyzes responses to electronic surveys to aid in the identification of responses affected by survey fatigue. In particular, the attention value analyzer 212 analyzes responses that include responses to questions (e.g., an answer choice selection for a question) or responses to pages (e.g., answer choice selections for all questions on a page). For example, the attention value analyzer 212 can analyze a response by determining how long it takes for a respondent to answer a question, complete a page of questions, or complete any other portion of the survey. As one will appreciate, attention value analyzer 212 may consider cumulative time to answer a question or page (e.g., if the respondent navigated back and forth through the survey viewing a question or page multiple times) or the time the respondent spent on the last viewing of the question or page before providing a complete answer.

Further, in one or more embodiments the attention value analyzer 212 determines attention values for responses to one or more questions, pages, or other elements of an electronic survey. In particular, the attention value analyzer 212 analyzes responses to elements of electronic surveys to determine attention values corresponding to those elements. Attention values indicate the relationship between an actual response to an individual element and an expected response to an individual element.

For example, in one or more embodiments the attention value analyzer 212 determines an attention value for an element by dividing an actual response duration for the element by an expected response duration for the element (i.e. the actual time it took the respondent to respond to the element divided by the expected time for responding to that element, calculated as follows: actual response duration/expected response duration=attention value). Thus, assuming a respondent took 15 seconds to provide a response to a question and the expected response duration for the question was 20 seconds, then the attention value for that question would be 0.75 (i.e. 15 seconds/20 seconds=0.75 attention value). As another example, the attention value analyzer 212 can determine an attention value for an element by dividing the expected response duration for the element by the actual response duration for the element (i.e. the expected time for responding to the element divided by the actual time it took the respondent to respond to the element, calculated as follows: expected response duration/actual response duration=attention value). Thus, using the same illustration from above the attention value would be 1.33 (i.e. 20 seconds/15 second=1.33 attention value).

In addition, attention value analyzer 212 can determine expected response durations for questions and/or pages in the same manner as survey analyzer 202 described above. Furthermore, attention value analyzer 212 accesses survey data storage 220 to identify expected response durations that correspond to elements analyzed by survey analyzer 202. Accordingly, survey analyzer 202 can store expected response durations (i.e., element durations, such as question durations, answer choice durations, and/or page durations) in survey data storage 220.

Moreover, attention value analyzer 212 can calculate attention values in numerous other ways. For example, attention value analyzer 212 can calculate attention values based on various user input factors. User input factors used by attention value analyzer 212 can include clicks, mouse movements, gyroscope movement in a mobile computing device, eye tracking data (e.g., as detected by a mobile computing device camera), audio data (e.g., as detected by a mobile computing device microphone), and changes in focus between user interface windows or applications. Accordingly, attention value analyzer 212 can detect a variety of user input to infer attention on the part of respondents or a lack thereof.

In addition, FIG. 2 shows that in one or more embodiments the survey management system 106 can include a survey fatigue identifier 214 that determines whether a response was affected by survey fatigue. In particular, in one or more embodiments, the survey fatigue identifier 214 determines that a response was affected by survey fatigue by comparing the attention value for that response with the attention values of one or more other responses. In one or more embodiments, an attention value can represent a ratio between an expected survey element duration (e.g., an expected question duration) and an actual response duration. The survey fatigue identifier 214 determines that a response was affected by survey fatigue because the difference between the attention value for that response and the attention value for another response exceeds a threshold value (e.g., a standard deviation, percentage, etc.). To illustrate, assume a respondent provides a 15 second response to a first question that was expected to take 20 seconds, thereby creating a first attention value of 0.75. Further assume the respondent provides a 5 second response to a second question that was expected to take 20 seconds, thereby creating a second attention value of 0.25. Therefore, the difference between the first and second attention values is 0.50. Assuming a threshold value of 0.25, in one or more embodiments the survey fatigue identifier 214 would determine that the second question was affected by survey fatigue because the 0.50 difference between the attention values exceeds the 0.25 threshold value. As one can appreciate, the survey fatigue identifier 214 can also identify survey fatigue by comparing an attention value for a particular element (e.g., a question or page) to an average of the attention values corresponding to other elements (e.g., average of attention values for all other questions or pages in the survey). Accordingly, in one or more embodiments the survey fatigue identifier 214 identifies whether responses were affected by survey fatigue by comparing responses to each other (e.g., comparing a respondent's question responses to one another or comparing a respondent's page responses to one another).

Moreover, in one or more embodiments, the survey fatigue identifier 214 can employ a variety of other methods to determine whether a response was affected by survey fatigue. For example, the survey fatigue identifier 214 can identify survey fatigue by comparing responses to historical survey data (e.g., prior survey data and metrics stored in data storage 218). As another example, the survey fatigue identifier 214 can identify survey fatigue by comparing responses to average attention values calculated across a large volume of questions or surveys. Furthermore, by detecting that survey fatigue is erroneously identified in a particular element (e.g., at a higher than typical frequency), survey fatigue identifier 214 can adjust the expected element duration to more accurately identify survey fatigue.

As also shown by FIG. 2, in one or more embodiments the survey management system 106 can include a survey fatigue manager 216 that manages responses affected by survey fatigue. For example, in one or more embodiments the survey fatigue manager 216 provides a notification to a respondent that a response to a question or page was affected by survey fatigue (e.g., while the respondent is answering an electronic survey or once the respondent is finished answering the electronic survey). As another example, in one or more embodiments the survey fatigue manager 216 sets a survey fatigue indicator associated with responses affected by survey fatigue (e.g., setting the indicator on responses to electronic surveys stored in data storage 218). As a further example, in one or more embodiments the survey fatigue manager 218 filters out (either automatically or based on threshold, such as one set by administrator 102) responses affected by survey fatigue in order to exclude such responses from electronic survey results analyzed by an administrator. As yet another example, in one or more embodiments the survey fatigue manager 218 provides, to an administrator, an indication of responses affected by survey fatigue, which may include a survey fatigue score for each response (e.g., based on an attention value or difference from average attention values for the respondent).

Furthermore, in one or more embodiments the survey fatigue manager 218 provides a notification that a particular element (e.g., question or page) is triggering survey fatigue on the part of respondents. More specifically, the survey fatigue manager 218 may determine that survey fatigue identifier 216 regularly identifies survey fatigue affecting a particular element. Accordingly, the survey fatigue manager 218 may provide a suggestion to the administrator of the electronic survey to modify the particular element that is triggering survey fatigue.

Additionally, FIG. 2 illustrates that in one or more embodiments the survey management system 106 can include a data storage 218 that stores electronic information associated with predicting and/or identifying survey fatigue. In one or more embodiments data storage 218 includes survey data storage 220. For example, in one or more embodiments survey data storage 220 stores information related to electronic surveys, such as survey definitions, target respondent information, survey elements (e.g., questions, answer choices, pages, etc.), and expected survey durations (e.g., as determined by survey analyzer 202). Further, in one or more embodiments data storage 218 includes respondent data storage 222. As an example, in one or more embodiments respondent data storage 222 stores information related to electronic survey respondents, such as expected respondent commitment levels, expected respondent commitment durations, responses to electronic surveys (e.g. respondent responses to questions, pages, and/or surveys), and attention values related to responses. As one will appreciate, in one or more embodiments data storage 218 includes one or more storage devices and/or computer-readable media. Furthermore, as one will appreciate, in one or more embodiments data storage 218 includes one or more databases (e.g., relational databases, non-relational databases, XML databases, JSON databases, SQL databases, NoSQL databases, cloud databases, etc.).

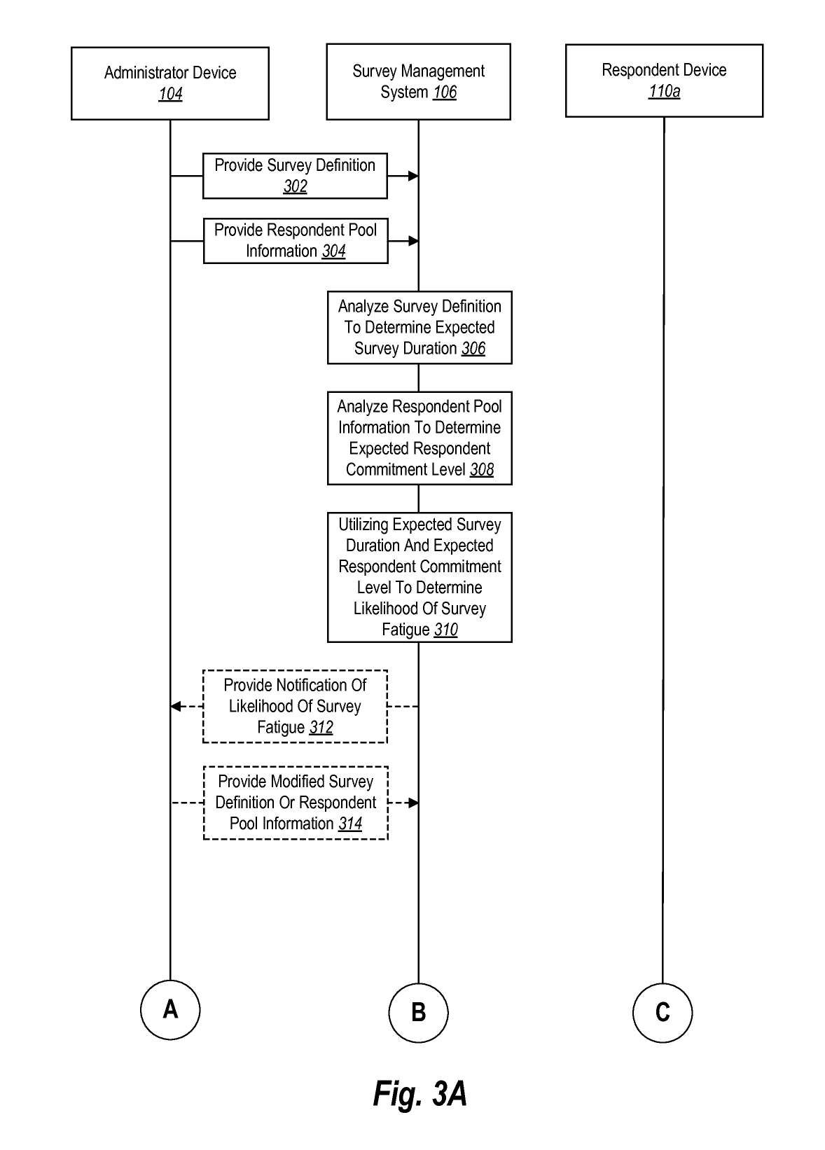

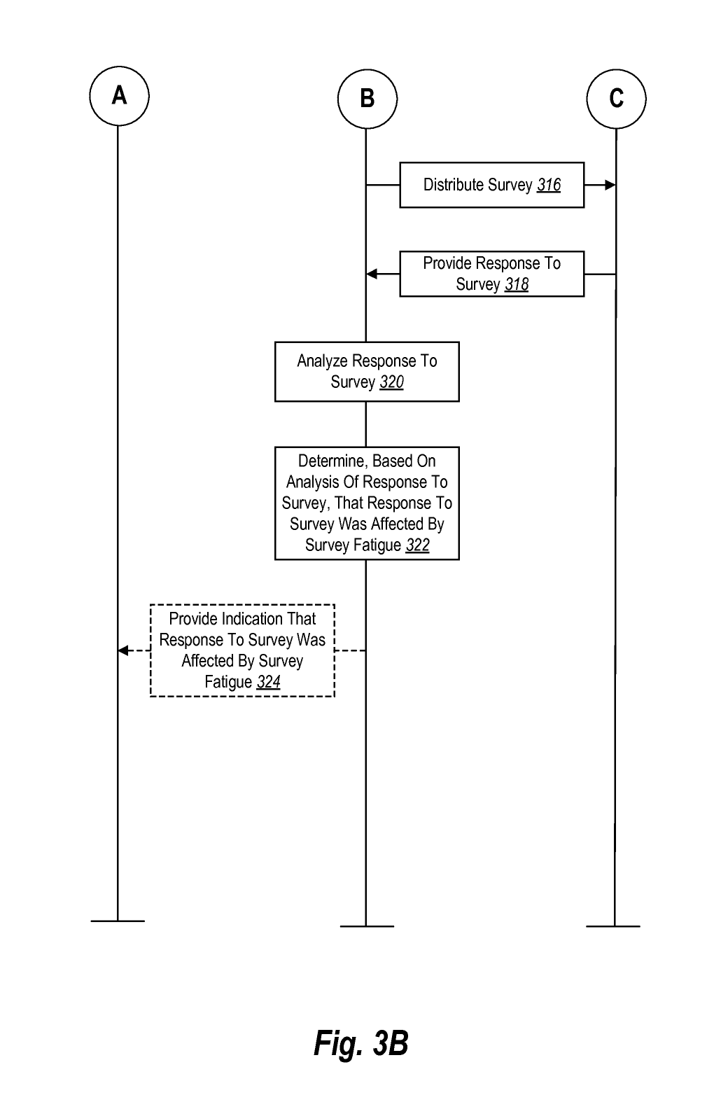

Referring now to FIGS. 3A-3B, which illustrate a sequence-flow diagram of interactions between the administrator device 104, the survey management system 106, and the respondent device 110a of FIG. 1. The sequence-flow diagram of FIGS. 3A-3B illustrate an example timeline of interactions between the administrator device 104, the survey management system 106, and respondent device 110a of FIG. 1, in accordance with one or more embodiments of the present invention.

As shown at 302, administrator device 104 provides survey management system 106 with a survey definition of an electronic survey. In particular, administrator 102 uses administrator device 104 to create a survey definition by specifying questions, answer choices, pages, and other characteristics of an electronic survey (e.g., display logic, etc.). In one or more embodiments, the administrator 102 creates the survey definition on administrator device 104 and then communicates the survey definition to survey management system 106 (e.g., as an Extensible Markup Language (XML) or JavaScript Object Notation file) using the administrator device 104. For example, the administrator 102 may use a local application on administrator device 104 to build an electronic survey by creating a survey definition. Alternatively, in one or more embodiments, the administrator 102 accesses survey management system 106 using administrator device 104 in order to create the survey definition on survey management system 106. For example, the administrator 102 may use a webpage interface provided by survey management system 106 to create a survey definition for an electronic survey.

At 304, administrator device 104 provides survey management system 106 with respondent pool information for an electronic survey. In particular, administrator 102 uses administrator device 104 to specify information relating to the intended or potential respondents of the electronic survey. For example, the administrator device 104 provides the survey management system 106 with information about intended or potential respondents (e.g., respondent characteristics, such as respondent type, respondent demographic information, etc.). As another example, the administrator device 104 provides the survey management system 106 with an identification of specific respondents (e.g., a contact list in Extensible Markup Language (XML) or JavaScript Object Notation (JSON) format). As a further example, the administrator device 104 provides an indication of an expected respondent commitment level (e.g., very low, low, medium, high) for respondents of the electronic survey. Additionally or alternatively, the administrator device 104 provides an indication of an expected respondent commitment duration for respondents of the electronic survey (e.g., 0 to 30 seconds, 31 seconds to 2 minutes, 2:01 minutes to 10 minutes, 10:01 minutes or more).

As illustrated by 306, the survey management system 106 analyzes the survey definition of an electronic survey to determine an expected survey duration. More specifically, the survey management system 106 analyzes the duration of one or more elements of the survey definition to determine an expected survey duration (e.g., as previously described with respect to the survey analyzer 202 of FIG. 2).

As indicated by 308, the survey management system 106 analyzes respondent pool information to determine an expected respondent commitment level. In particular, the survey management system 106 analyzes the respondent pool information as previously described with respect to the respondent analyzer 204 of FIG. 2.

As shown by 310, the survey management system 106 then utilizes the expected survey duration and expected respondent commitment level to determine a likelihood of survey fatigue for the electronic survey. More specifically, the survey management system 106 determines a likelihood of survey fatigue by comparing the expected survey duration with an expected respondent commitment duration that is based upon the expected respondent commitment level (e.g., as described above with respect to survey fatigue predictor 206 of FIG. 2). For example, the survey management system 106 determines an expected respondent commitment duration that corresponds to the expected respondent commitment level (e.g., by looking up in a table or other suitable data structure, such as FIG. 4, as described in further detail below), and then compares the expected respondent commitment duration to the expected survey duration to predict the likelihood of survey fatigue.

As illustrated by 312, the survey management system 106 optionally provides a notification of the likelihood of survey fatigue. In particular, once the survey management system 106 has determined the likelihood of survey fatigue posed by a particular electronic survey, the survey management system 106 may provide a notification of the likelihood of survey fatigue to administrator 102 via administrator device 104 (e.g., by sending the notification as previously described with respect to the survey manager 208 of FIG. 2).

As indicated by 314, the administrator device 104 optionally provides a modified survey definition or respondent pool information to the survey management system 106. More specifically, in response to a notification of a likelihood of survey fatigue, the administrator 102 may use administrator device 104 to modify the survey definition and/or the respondent pool information in order to eliminate or reduce the likelihood of survey fatigue. Upon receiving the modified survey definition and/or respondent pool information from administrator device 104, the survey management system 106 may analyze the modified survey definition and/or respondent pool information to determine a modified likelihood of survey fatigue (e.g., the survey management system 106 may repeat one or more of steps 306, 308, or 310 using the modified survey definition and/or respondent pool information received in step 314). Further, upon determining a modified likelihood of survey fatigue, the survey management system 106 may provide a new notification of likelihood of survey fatigue to administrator device 104 in a manner similar to step 312.

Moreover, as shown by 316, the survey management system 106 distributes an electronic survey to respondent device 110a. In particular, the survey management system 106 distributes an electronic survey to respondent 112a via respondent device 110a, as previously described with respect to survey distributor 210 of FIG. 2. For example, survey management system 106 may provide a portion of the electronic survey to respondent device 110a (e.g., a question or page at a time). As another example, survey management system 106 may provide the entire electronic survey to respondent device. Moreover, as one can appreciate, while 316 shows survey management system 106 communicating with respondent device 110a alone, survey management system 106 can distribute an electronic survey to any number of respondent devices.

As illustrated by 318, the respondent device 110a provides a response to the electronic survey. More specifically, in response to receiving an electronic survey, respondent 112a uses respondent device 110a to provide survey management system 106 with a response to the electronic survey. For example, respondent 112a uses respondent device 110a to provide a response to survey management system 106 by answering a question, a page, or an electronic survey as a whole. Thus, as one will appreciate, a response includes a response to a question, a response to a page, or a response to an entire electronic survey. Additionally, respondent device 110a may provide to survey management system 106 an indication of how long it took respondent 112a to make the response (e.g., an indication of an actual response duration for an element of an electronic survey). Furthermore, as one can appreciate, while 318 shows survey management system 106 receiving a response from respondent device 110a alone, survey management system 106 can receive responses to electronic surveys from any number of respondent devices.

Furthermore, as shown by 320, the survey management system 106 analyzes the response to the electronic survey. More specifically, the survey management system 106 analyzes the response to the electronic survey to determine a corresponding attention value for the response, as described above in detail with regard to attention value analyzer 212 of FIG. 2. For example, the survey management system 106 may determine a corresponding attention value based on an analysis of an expected response duration and an actual response duration associated with the response. Additionally or alternatively, the survey management system 106 may determine an attention value for a response by analyzing the variability of the answers provided in the response (e.g., low answer variability or a lack of answer variability may imply survey fatigue affected the response). Furthermore, the survey management system 106 may determine an attention value for a response by analyzing the variability of answers in combination with the actual duration associated with the response.

As illustrated by 322, the survey management system 106 determines, based on the analysis of the response to the electronic survey, that the response was affected by survey fatigue. In particular, the survey management system 106 identifies one or more responses affected by survey fatigue as described with respect to survey fatigue identifier 214 of FIG. 2. For example, the survey management system 106 can determine that a response was affected by survey fatigue based on a comparison of the attention value for that response to the attention values of one or more other responses.

Furthermore, as shown by 324, the survey management system 106 optionally provides an indication that a response was affected by survey fatigue. More specifically, survey management system 106 optionally provides the indication of survey fatigue to the administrator device 104, as previously described with respect to survey fatigue manager 216 of FIG. 2. For example, the survey management system 106 may flag or otherwise mark the response to indicate to the administrator 102 that survey fatigue affected the response. Alternatively, the survey management system 106 may remove or otherwise exclude the response from the survey results in order to provide administrator 104 with more accurate survey results.

Accordingly, as the sequence-flow diagram of FIGS. 3A-3B illustrates, the survey management system 106 can improve the accuracy of electronic surveys in a variety of ways. In particular, the survey management system 106 can predict whether an electronic survey is likely to produce survey fatigue. Furthermore, the survey management system 106 can identify whether a response to an electronic survey was affected by survey fatigue. Consequently, the survey management system 106 can reduce or eliminate the potential for survey fatigue, thereby providing advantages and benefits over prior electronic survey methods and systems.

FIG. 4 illustrates a respondent commitment table 400 in accordance with one or more embodiments. More specifically, FIG. 4 shows a respondent commitment table 400 that includes one or more expected respondent commitment levels 402 corresponding to one or more expected respondent commitment durations 404. In one or more embodiments, survey management system 106 (e.g., respondent analyzer 204) can use the respondent commitment table 400 (or a similarly suitable data structure) to identify an expected respondent commitment duration for an electronic survey. For example, survey management system 106 (e.g., respondent analyzer 204) can use an expected respondent commitment level to identify a corresponding expected respondent commitment duration.

As described herein, survey management system 106 (e.g., respondent analyzer 204) can identify an expected respondent commitment level in a variety of ways. For example, survey management system 106 may identify the expected respondent commitment level based upon the respondent pool information. Thus, survey management system 106 may prompt administrator 102 to provide the expected respondent commitment level as part of the respondent pool information. Alternatively, survey management system 106 may determine the expected respondent commitment level based on an analysis of intended or potential respondents (e.g., an analysis of respondent profile information, respondent type, etc.).

By way of illustration with respect to FIG. 4, survey management system 106 (e.g., respondent analyzer 204) can use an expected respondent commitment level of “low” to identify a corresponding expected respondent commitment duration of “31 seconds to 2 minutes”. Accordingly, as previously described herein, the identified expected respondent commitment duration can then be used by survey fatigue predictor 206 to predict whether survey fatigue is likely. As such, survey management system 106 can use a table or other suitable data structure to look up or access information to facilitate the identification or prediction of survey fatigue.

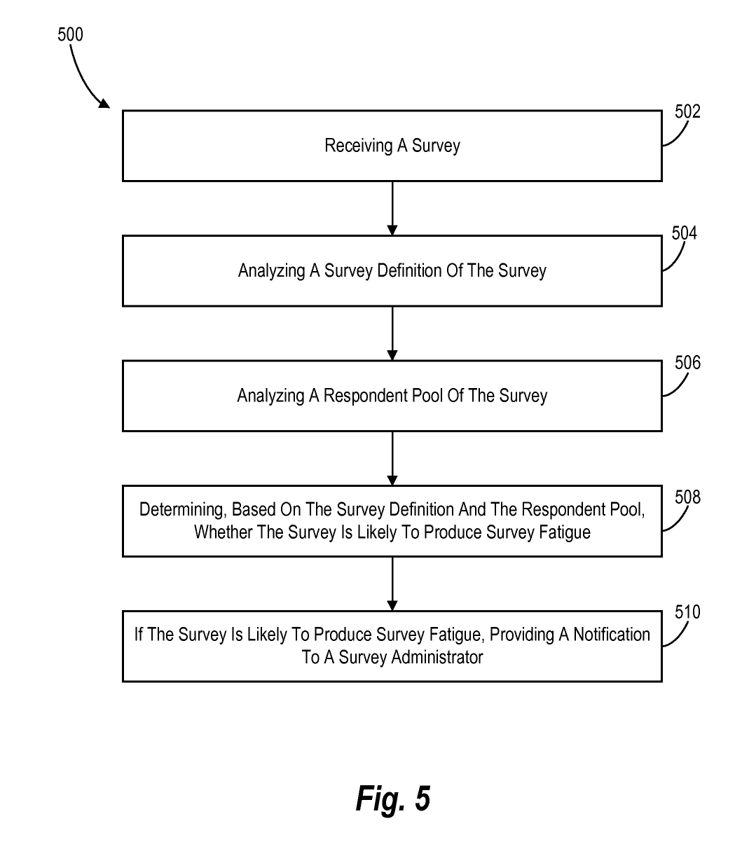

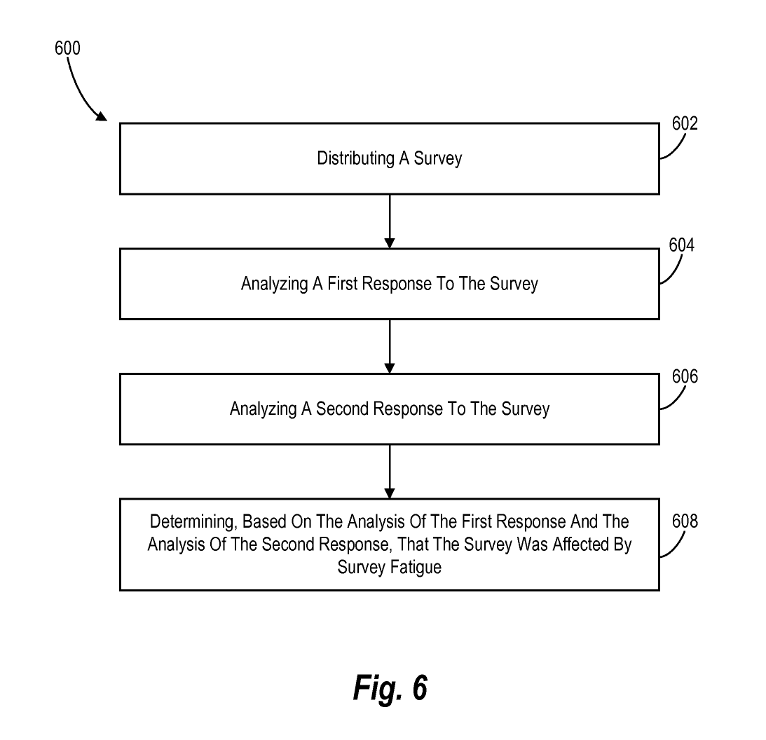

FIGS. 1-4, the corresponding text, and the examples, provide a number of different systems and methods for predicting and identifying survey fatigue associated with administering electronic surveys. In addition to the foregoing, embodiments also can be described in terms of flowcharts comprising acts and steps in a method for accomplishing a particular result. For example, FIGS. 5-6 illustrate flowcharts of exemplary methods in accordance with one or more embodiments.

FIG. 5 illustrates a flow chart of one exemplary method 500 of predicting whether an electronic survey is likely to produce survey fatigue from the perspective of a survey management system 106. The method 500 can include an act 502 of receiving a survey. In particular, act 502 can involve receiving a survey that comprises a survey definition and respondent pool information. The survey definition can include an indication of one or more questions, one or more pages, and/or display logic. The respondent pool information can include an indication of an expected respondent commitment level, an indication of an expected respondent commitment duration, an identification of intended respondents, and/or an indication of characteristics of potential respondents. Moreover, act 502 can involve receiving the survey definition and the respondent pool information together or separately (e.g., in the same XML or JSON document or in separate XML or JSON documents). In one or more embodiments, receiving a survey 502 can comprise receiving, via a web application, user input from an administrator, wherein the user input specifies one or more questions of a survey, one or more pages of the survey, display logic of the survey, and an expected respondent commitment level.

The method 500 may also include an act 504 of analyzing a survey definition of the survey. More specifically, act 504 can involve analyzing one or more elements of a survey definition to determine an expected survey duration. For example, act 504 can involve identifying an element duration for each of the one or more elements of the survey definition and summing each element duration to determine the expected survey duration. Further, act 504 can involve identifying a user interaction duration for each page indicated by the survey definition (e.g., a value to account for respondent eye movement, input, scrolling, or page navigation). Accordingly, act 504 can involve adding the user interaction duration as part of the expected survey duration. Moreover, act 504 can involve simulating administration of the electronic survey multiple times to determine the expected survey duration.

FIG. 5 further illustrates that the method 500 can include an act 506 of analyzing a respondent pool of the survey. In particular, act 506 can involve analyzing respondent pool information to identify an expected respondent commitment duration. For example, act 506 can involve the survey management system 106 prompting an administrator to provide an expected respondent commitment level (e.g., very low, low, medium, or high). In turn, act 506 can involve utilizing a respondent commitment table (e.g., as shown by FIG. 4) to identify the expected respondent commitment duration that corresponds to the expected respondent commitment level provided by the administrator. As another example, act 506 can involve identifying prior respondent commitment durations associated with respondent profiles indicated by the respondent pool information. Accordingly, act 506 can involve determining the expected respondent commitment duration based on the prior respondent commitment durations of the intended respondents (e.g., by determining the average of the prior respondent commitment durations). Furthermore, in one or more embodiments, analyzing a respondent pool of the survey 506 can involve identifying the expected respondent commitment duration based on a survey type for the survey and/or a category of the survey administrator.

Moreover, the method 500 can include an act 508 of determining, based on the survey definition and the respondent pool, whether the survey is likely to produce survey fatigue. Specifically, act 508 can involve utilizing the expected survey duration and the expected respondent commitment duration to determine whether the survey is likely to produce survey fatigue. For instance, act 508 can involve comparing the expected survey duration and the expected respondent commitment duration to determine whether the expected survey duration is greater than the expected respondent commitment duration. Additionally or alternatively, act 508 can involve determining whether a difference between the expected survey duration and the expected respondent commitment duration exceeds a threshold (e.g., a threshold input by administrator 102 or predetermined by survey management system 106). Accordingly, in one or more embodiments, even if the expected survey duration exceeds the expected respondent commitment duration, act 508 may determine that survey fatigue is not likely because the threshold difference is not exceeded.

Furthermore, the method 500 can include an act 510 of providing a notification to a survey administrator, if the survey is likely to produce survey fatigue. In particular, act 510 can involve providing a notification of likelihood of survey fatigue to a survey administrator prior to administration of the survey, if the survey is likely to produce survey fatigue. Furthermore, act 510 can involve providing a suggestion to modify the survey. More specifically, act 510 can involve suggesting that the administrator modify the survey definition and/or the respondent pool information. Consequently, in one or more embodiments, one or more of acts 502-510 may be repeated using a modified survey (e.g., a modified survey definition and/or modified respondent pool information). Additionally, act 510 can involve providing an identification of one or more elements (e.g. questions and/or pages) that may be modified to reduce the expected survey duration.

Referring now to FIG. 6, a flowchart of one exemplary method 600 of identifying responses to electronic surveys affected by survey fatigue from the perspective of a survey management system 106 is illustrated. As shown the method 600 can include an act 602 of distributing a survey. More specifically, act 602 can involve distributing a survey that comprises one or more elements to one or more respondents in a respondent pool. For example, act 602 can involve distributing a link to the survey, such as a hyperlink (e.g., an anonymous survey hyperlink or unique survey link). As another example, act 602 can involve distributing a link to the survey via email, Short Message Service (SMS), social media website, web page popup, and/or mobile application (e.g., offline survey application). Furthermore, in one or more embodiments, distributing a survey 602 can involve distributing a portion of the survey (e.g., one question or one page at a time) to one or more respondent devices. Alternatively, in one or more embodiments, distributing a survey 602 can involve distributing an entire survey (e.g., all questions and/or pages) to one or more respondent devices.

The method 600 can also include an act 604 of analyzing a first response to the survey. In particular, act 604 can involve analyzing a first response by a respondent to a first element of the survey to determine a first attention value that corresponds to the first element. For example, act 604 can involve determining a first attention value based on a first expected response duration for the first response and a first actual response duration for the first response. Furthermore, act 604 can involve determining the first attention value by dividing the first actual response time by the first expected response time. Moreover, in one or more embodiments, analyzing a first response to the survey 604 can involve determining a first attention value based on how the first response varies from a respondent's other responses to the survey.

Further, FIG. 6 illustrates that method 600 can include an act 606 of analyzing a second response to the survey. More specifically, act 606 can involve analyzing a second response by a respondent to a second element of a survey to determine a second attention value that corresponds to the second element. Like in act 604, act 606 can involve determining a second attention value based on a second expected response duration for the second response and a second actual response duration for the second response. Additionally, act 606 can involve determining the second attention value by dividing the first actual response time by the first expected response time. Also, as in one or more embodiments of act 604, analyzing a second response to the survey 606 can involve determining a second attention value based on how the second response varies from a respondent's other responses to the survey.

FIG. 6 also shows that method 600 can include an act 608 of determining, based on the analysis of the first response and the analysis of the second response, that the survey was affected by survey fatigue. In particular, act 608 can involve determining, based on a comparison of a first attention value to a second attention value, that the second response was affected by survey fatigue. For example, act 608 can involve determining that a difference between the first attention value of the first response and the second attention value of the second response exceeds a threshold to determine that the second response was affected by survey fatigue. Additionally, act 608 can involve providing a notification to the respondent that indicates the second response was affected by survey fatigue. Further, in one or more embodiments, act 608 can involve setting a survey fatigue indicator associated with the second response and/or filtering the second response from survey results provided to an administrator.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that one or more computing devices such as the computing device 700 may implement administrator device 104, survey management system 106, and/or respondent devices 110a-110c. As shown by FIG. 7, the computing device 700 can comprise a processor 702, a memory 704, a storage device 706, an I/O interface 708, and a communication interface 710, which may be communicatively coupled by way of a communication infrastructure 712. While an exemplary computing device 700 is shown in FIG. 7, the components illustrated in FIG. 7 are not intended to be limiting. Additional or alternative components may be used in other embodiments. Furthermore, in certain embodiments, the computing device 700 can include fewer components than those shown in FIG. 7. Components of the computing device 700 shown in FIG. 7 will now be described in additional detail.

In one or more embodiments, the processor 702 includes hardware for executing instructions, such as those making up a computer program. As an example and not by way of limitation, to execute instructions, the processor 702 may retrieve (or fetch) the instructions from an internal register, an internal cache, the memory 704, or the storage device 706 and decode and execute them. In one or more embodiments, the processor 702 may include one or more internal caches for data, instructions, or addresses. As an example and not by way of limitation, the processor 702 may include one or more instruction caches, one or more data caches, and one or more translation lookaside buffers (TLBs). Instructions in the instruction caches may be copies of instructions in the memory 704 or the storage 706.

The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The storage device 706 includes storage for storing data or instructions. As an example and not by way of limitation, storage device 706 can comprise a non-transitory storage medium described above. The storage device 706 may include a hard disk drive (HDD), a floppy disk drive, flash memory, an optical disc, a magneto-optical disc, magnetic tape, or a Universal Serial Bus (USB) drive or a combination of two or more of these. The storage device 706 may include removable or non-removable (or fixed) media, where appropriate. The storage device 606 may be internal or external to the computing device 600. In one or more embodiments, the storage device 706 is non-volatile, solid-state memory. In other embodiments, the storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 708 allows a user to provide input to, receive output from, and otherwise transfer data to and receive data from computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 712 may include hardware, software, or both that couples components of the computing device 700 to each other. As an example and not by way of limitation, the communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 8 illustrates an example network environment 800 of a survey management system, such as survey management system 106. Network environment 800 includes a client system 806, and a survey management system 802 connected to each other by a network 804. Although FIG. 8 illustrates a particular arrangement of client system 806, survey management system 802, and network 804, this disclosure contemplates any suitable arrangement of client system 806, survey management system 802, and network 804. As an example and not by way of limitation, two or more of client system 806, and survey management system 802 may be connected to each other directly, bypassing network 804. As another example, two or more of client system 806 and survey management system 802 may be physically or logically co-located with each other in whole, or in part. Moreover, although FIG. 8 illustrates a particular number of client systems 806, survey management systems 802, and networks 804, this disclosure contemplates any suitable number of client systems 806, survey management systems 802, and networks 804. As an example and not by way of limitation, network environment 800 may include multiple client systems 806, survey management systems 802, and networks 804.

This disclosure contemplates any suitable network 804. As an example and not by way of limitation, one or more portions of network 804 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 804 may include one or more networks.

Links may connect client system 806, and survey management system 802 to communication network 804 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, client system 806 may be an electronic device including hardware, software, or embedded logic components or a combination of two or more such components and capable of carrying out the appropriate functionalities implemented or supported by client system 806. As an example and not by way of limitation, a client system 806 may include any of the computing devices discussed above in relation to FIG. 7. A client system 806 may enable a network user at client system 806 to access network 804. A client system 806 may enable its user to communicate with other users at other client systems 806.

In particular embodiments, client system 806 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at client system 806 may enter a Uniform Resource Locator (URL) or other address directing the web browser to a particular server (such as server, or a server associated with a third-party system), and the web browser may generate a Hyper Text Transfer Protocol (HTTP) request and communicate the HTTP request to server. The server may accept the HTTP request and communicate to client system 806 one or more Hyper Text Markup Language (HTML) files responsive to the HTTP request. Client system 806 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, survey management system 802 may include a variety of servers, sub-systems, programs, modules, logs, and data stores. In particular embodiments, survey management system 802 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Survey management system 802 may also include suitable components such as network interfaces, security mechanisms, load balancers, failover servers, management-and-network-operations consoles, other suitable components, or any suitable combination thereof.

In particular embodiments, survey management system 802 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories and categories may be general or specific.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method comprising:
receiving a survey that comprises a survey definition and respondent pool information;
analyzing, using at least one processor, one or more elements of the survey definition to determine an expected survey duration;
analyzing, using the at least one processor, the respondent pool information to identify an expected respondent commitment duration;
utilizing the expected survey duration and the expected respondent commitment duration to determine whether the survey is likely to produce survey fatigue; and
if the survey is likely to produce survey fatigue, providing a notification of likelihood of survey fatigue to a survey administrator prior to administration of the survey.

2. The method of claim 1, further comprising:
identifying an element duration for each of the one or more elements of the survey definition; and
summing each element duration to determine the expected survey duration.

3. The method of claim 1, further comprising:
determining a question duration for each question indicated by the survey definition;
determining a page duration for each page indicated by the survey definition; and
summing the determined page durations to determine the expected survey duration.

4. The method of claim 3, further comprising dividing a word count for each question indicated by the survey definition by an expected respondent reading speed to determine the question duration for each question indicated by the survey definition.

5. The method of claim 3, further comprising summing the question duration for each question on each page to determine the page duration for each page indicated by the survey definition.

6. The method of claim 1, further comprising simulating administration of the survey multiple times to determine a plurality of survey durations used to determine the expected survey duration.

7. The method of claim 6, further comprising:
determining a first survey duration based on a first path through the survey;
determining a second survey duration based on a second path through the survey; and
utilizing the first survey duration and the second survey duration to determine the expected survey duration.

8. The method of claim 1, further comprising:
identifying an expected respondent commitment level indicated by the respondent profile information; and
identifying the expected respondent commitment duration that corresponds to the expected respondent commitment level.

9. The method of claim 1, further comprising comparing the expected survey duration and the expected respondent commitment duration to determine whether the expected survey duration is greater than the expected respondent commitment duration.

10. The method of claim 1, further comprising determining whether a difference between the expected survey duration and the expected respondent commitment duration exceeds a threshold.

11. The method of claim 1, further comprising providing, to the survey administrator, a suggestion to modify the survey.

12. The method of claim 11, wherein the suggestion to modify the survey comprises an identification of one or more elements of the survey definition that may be modified to reduce the expected survey duration.

13. A method comprising:
distributing a survey that comprises one or more elements to one or more respondents in a respondent pool;
analyzing, using at least one processor, a first response by a respondent to a first element of the survey to determine a first attention value that corresponds to the first element;
analyzing, using the at least one processor, a second response by the respondent to a second element of the survey to determine a second attention value that corresponds to the second element; and
determining, based on a comparison of the first attention value to the second attention value, that the second response was affected by survey fatigue.

14. The method of claim 13, further comprising distributing the survey via one or more of a link, an email, a Short Message Service message, a social media website, a web page popup, or a mobile application.

15. The method of claim 13, further comprising:
identifying a first expected response duration for the first response;
determining a first actual response duration for the first response;
determining the first attention value based on the first expected response duration and the first actual response duration;
identifying a second expected response duration for the second response;
determining a second actual response duration for the second response; and
determining the second attention value based on the second expected response duration and the second actual response duration.

16. The method of claim 15, further comprising:
determining the first attention value by dividing the first actual response time by the first expected response time; and
determining the second attention value by dividing the second actual response time by the second expected response time.

17. The method of claim 13, further comprising:
determining the first attention value based on how the first response varies from one or more other responses of the respondent to the survey; and
determining the second attention value based on how the second response varies from one or more other responses of the respondent to the survey.

18. The method of claim 13, further comprising:
determining that a difference between the first attention value and the second attention value exceeds a threshold; and
determining that the second response was affected by survey fatigue based on the difference exceeding the threshold.

19. The method of claim 13, further comprising providing a notification to the respondent that indicates the second response was affected by survey fatigue.

20. A survey management system comprising:
one or more server computing devices; and
a non-transitory storage medium comprising instructions that, when executed by the one or more server computing devices, cause the survey management system to:
receive a survey that comprises a survey definition and respondent pool information;
analyze one or more elements of the survey definition to determine an expected survey duration;
analyze the respondent pool information to identify an expected respondent commitment duration;
utilize the expected survey duration and the expected respondent commitment duration to determine whether the survey is likely to produce survey fatigue; and
if the survey is likely to produce survey fatigue, provide a notification of likelihood of survey fatigue to a survey administrator prior to administration of the survey.
